(19) United States
(12) Patent Application Publication
(10) Pub. No.: US 2026/0058253 A1
(43) Pub. Date: Feb. 26, 2026

(54) BATTERY ASSEMBLY

(71) Applicant: Prime Planet Energy & Solutions, Inc., Tokyo (JP)

(72) Inventors: Tetsuji OMURA, Kobe-shi (JP); Nao KOGAMI, Himeji-shi (JP)

(21) Appl. No.: 19/269,040

(22) Filed: Jul. 15, 2025

(30) Foreign Application Priority Data
Aug. 20, 2024 (JP) 2024-138492

(51) Int. Cl. H01M 10/658; H01M 10/647; H01M 50/209; H01M 50/293

(52) U.S. Cl. CPC H01M 10/658; H01M 10/647; H01M 50/209; H01M 50/293

(57) ABSTRACT

An insulating member provided between the plurality of batteries includes a main body composed of a heat insulating material and having a plate shape, and a film that covers the main body, and the film has a fixation portion that is folded back and fixed in an overlapping state at an end portion of the insulating member in a second direction orthogonal to the first direction.

### CROSS REFERENCE TO RELATED APPLICATIONS

This nonprovisional application is based on Japanese Patent Application No. 2024-138492 filed on Aug. 20, 2024 with the Japan Patent Office, the entire contents of which are hereby incorporated by reference.

### BACKGROUND OF THE INVENTION

### Field of the Invention

The present technology relates to a battery assembly.

### Description of the Background Art

In a battery assembly in which a plurality of batteries are arranged, an insulating member has been conventionally disposed between the plurality of batteries. A battery assembly described in WO 2018/061894 is an exemplary conventional battery assembly.

### SUMMARY OF THE INVENTION

It is required to improve a heat insulating effect between adjacent batteries by disposing the insulating member. Moreover, it is also required to improve durability of the insulating member. From the viewpoint of improving the heat insulating effect and durability of the insulating member, there is still room for improvement in the conventional battery assembly.

An object of the present technology is to provide a battery assembly in which heat insulating effect and durability of an insulating member provided between a plurality of batteries are high.

The present technology provides the following battery assembly.

[1] A battery assembly comprising: a plurality of batteries arranged in a first direction; and an insulating member provided between the plurality of batteries, wherein the insulating member includes a main body composed of a heat insulating material and having a plate shape, and a film that covers the main body, and the film has a fixation portion that is folded back and fixed in an overlapping state at an end portion of the insulating member in a second direction orthogonal to the first direction.

[2] The battery assembly according to [1], wherein the main body of the insulating member is formed to be relatively thin at a portion of the main body facing the fixation portion of the film.

[3] The battery assembly according to [1] or [2], wherein the fixation portion has a size of 3 mm or more and 15 mm or less in the second direction.

[4] The battery assembly according to any one of [1] to [3], wherein each of the plurality of batteries includes a housing that accommodates an electrode assembly, and the fixation portion has a size 0.006 times or more and 0.3 times or less as large as a size of the housing of the battery in the second direction.

[5] The battery assembly according to any one of [1] to [4], wherein each of the plurality of batteries includes a housing that accommodates an electrode assembly, and the insulating member is provided across a whole of the housing of the battery in the second direction.

[6] The battery assembly according to any one of [1] to [5], wherein the insulating member further includes an elastic body configured as a member different from a member constituted of the main body and the film, the elastic body being stacked in the first direction, the elastic body includes a base portion and a pressing portion, and the pressing portion is provided to avoid the fixation portion of the film when viewed in the first direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery assembly.

FIG. 2 is a perspective view of a battery included in the battery assembly.

FIG. 3 is a diagram showing a configuration of an insulating member (separator) according to a first embodiment.

FIG. 4 is a diagram showing a configuration of an insulating member (separator) according to a second embodiment.

FIG. 5 is a diagram showing a first step of a process of manufacturing the insulating member (separator).

FIG. 6 is a diagram showing a second step of the process of manufacturing the insulating member (separator).

FIG. 7 is a diagram showing a third step of the process of manufacturing the insulating member (separator).

FIG. 8 is a diagram for illustrating a range of a folded portion of a film.

FIG. 9 is a schematic view of a side surface of a wound type electrode assembly.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode.

The “battery” in the present specification can be mounted on vehicles such as a hybrid electric vehicle (HEV), a plug-in hybrid electric vehicle (PHEV), and a battery electric vehicle (BEV). It should be noted that the use of the “battery” is not limited to the use in a vehicle.

FIG. 1 is a perspective view of a battery module according to the present embodiment. As shown in FIG. 1, battery assembly 1 includes batteries 100 and separators 200. Batteries 100 and separators 200 are arranged alternately along a Y axis direction (first direction). Batteries 100 and separators 200 arranged are held with batteries 100 and separators 200 being restrained in the Y axis direction using restraint members (bind bars and end plates) (not shown) or a pack case (not shown).

The plurality of batteries 100 are batteries each having a prismatic shape, and are provided along the Y axis direction. The plurality of batteries 100 are electrically connected together by a bus bar (not shown).

Separators 200 are provided between the plurality of batteries 100. Each of separators 200 is an insulating member that prevents unintended electrical conduction between adjacent batteries 100. Separator 200 secures an electrical insulation property between adjacent batteries 100. Separator 200 can also be provided between a battery 100 and an end plate (not shown).

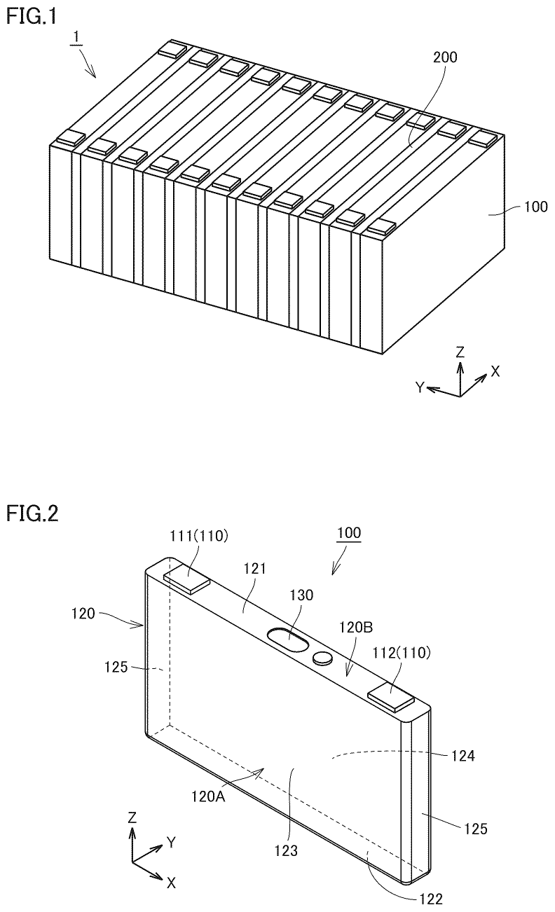

FIG. 2 is a perspective view showing each battery 100. As shown in FIG. 2, battery 100 has a prismatic shape. Battery 100 has electrode terminals 110, a housing 120, and a gas-discharge valve 130.

Electrode terminals 110 are formed on housing 120. Electrode terminals 110 have a positive electrode terminal 111 and a negative electrode terminal 112 arranged side by side along an X axis direction (second direction) orthogonal to the Y axis direction (first direction). Positive electrode terminal 111 and negative electrode terminal 112 are provided to be separated from each other in the X axis direction.

Housing 120 has a rectangular parallelepiped shape and forms an external appearance of battery 100. Housing 120 includes: a case main body 120A that accommodates an electrode assembly (not shown) and an electrolyte solution (not shown); and a sealing plate 120B that seals an opening of case main body 120A. Sealing plate 120B is joined to case main body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of batteries 100 are stacked such that first side surfaces 123 of batteries 100, 100 adjacent to each other in the Y direction face each other and second side surfaces 124 of batteries 100, 100 adjacent to each other in the Y axis direction face each other. Thus, positive electrode terminals 111 and negative electrode terminals 112 are alternately arranged in the Y axis direction in which the plurality of batteries 100 are stacked.

Gas-discharge valve 130 is provided in upper surface 121. When the temperature of battery 100 is increased (thermal runaway) and internal pressure of housing 120 becomes more than or equal to a predetermined value due to gas generated inside housing 120, gas-discharge valve 130 discharges the gas to outside of housing 120.

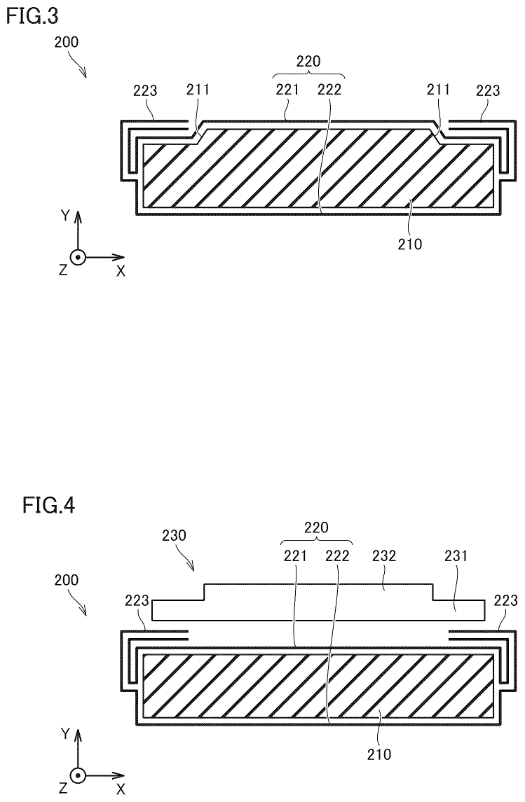

FIG. 3 is a diagram showing a configuration of a separator 200 (insulating member) according to one embodiment.

As shown in FIG. 3, separator 200 includes a main body 210 having a plate shape, and a film 220 (laminate material) that covers main body 210. Film 220 includes: a first film 221 that covers one surface of main body 210; and a second film 222 that covers the other surface of main body 210.

First film 221 and second film 222 are folded back and fixed in an overlapping state at end portions of separator 200 in the X axis direction. Thus, fixation portions 223 of film 220 are formed. It should be noted that although not shown in FIG. 3, the same configuration as that of each of fixation portions 223 shown in FIG. 3 may be provided at an end portion of separator 200 in the Z axis direction.

Further, film 220 may be constituted of one film, or three or more films may be used therefor. Moreover, fixation portions 223 shown in FIG. 3 is not limited to being formed at the both end portions in the X axis direction or the Z axis direction, and fixation portion 223 may be formed at one end portion in the X axis direction or the Z axis direction.

Main body 210 is composed of a heat insulating material. Examples of the heat insulating material include glass wool, rock wool, cellulose fiber, and aerogel. Moreover, a molding material obtained by mixing an inorganic filler and a binder, or a material obtained by solidifying an inorganic fiber and an inorganic powder may be used.

Examples of the material of film 220 include PET (polyethylene terephthalate), PP (polypropylene), PE (polyethylene), PVC (polyvinyl chloride), and the like.

In the example of FIG. 3, main body 210 has a stepped portion 211. By providing stepped portion 211, main body 210 is formed to be relatively thin at a portion of main body 210 facing fixation portion 223 of film 220.

As one function of separator 200, it is required to improve a heat insulating effect between adjacent batteries 100 in battery assembly 1. From this viewpoint, main body 210 composed of the heat insulating material is preferably formed to be large.

On the other hand, it is also required to improve durability of separator 200. From this viewpoint, main body 210 is preferably covered with film 220, and the overlapping region at the joining portion of film 220 is preferably large. With such a large overlapping region, strength of the joining portion of film 220 can be improved and damage of the joining portion can be suppressed. As a result, the durability of main body 210 is also improved.

It should be noted that when the overlapping region at the joining portion of film 220 is large, interference with a member around separator 200 (such as a restraint member that restrains battery 100 in the Y axis direction) may occur.

In separator 200 shown in FIG. 3, film 220 is folded back and fixed in the overlapping state at fixation portion 223 located at the end portion in the X axis direction or the Z axis direction. Thus, the overlapping region at the joining portion of film 220 can be large while avoiding interference with the member therearound, thereby improving the durability of separator 200. Moreover, main body 210 composed of the heat insulating material can be formed to be large.

Thus, according to separator 200 of the present embodiment, it is possible to achieve both a high heat insulating effect and high durability.

FIG. 4 is a diagram showing a configuration of a separator 200 (insulating member) according to another embodiment.

Separator 200 shown in FIG. 4 is obtained by stacking an elastic body 230 configured as a member different from a member constituted of main body 210 and film 220. By providing elastic body 230, deformation (expansion) of battery 100 in the Y axis direction can be facilitated to be absorbed.

Elastic body 230 includes a base portion 231 and a pressing portion 232. Base portion 231 is preferably formed across a whole of separator 200. Thus, assembling of battery assembly 1 can be facilitated. Pressing portion 232 is formed only on the central side of separator 200. Pressing portion 232 is in abutment with adjacent battery 100. When battery assembly 1 is viewed in the Y axis direction, elastic body 230 is preferably disposed such that pressing portion 232 and fixation portion 223 of film 220 are not overlapped with each other.

That is, when viewed in the Y axis direction, pressing portion 232 of elastic body 230 is preferably provided at a position to avoid fixation portion 223 of film 220 (region not overlapped with fixation portion 223), and fixation portion 223 of film 220 is preferably provided at a position to avoid pressing portion 232 (region not overlapped with pressing portion 232). It should be noted that when pressing portion 232 is constituted of a plurality of protrusions, pressing portion 232 is a region formed by connecting outer peripheral edges of the plurality of protrusions located at the outermost periphery.

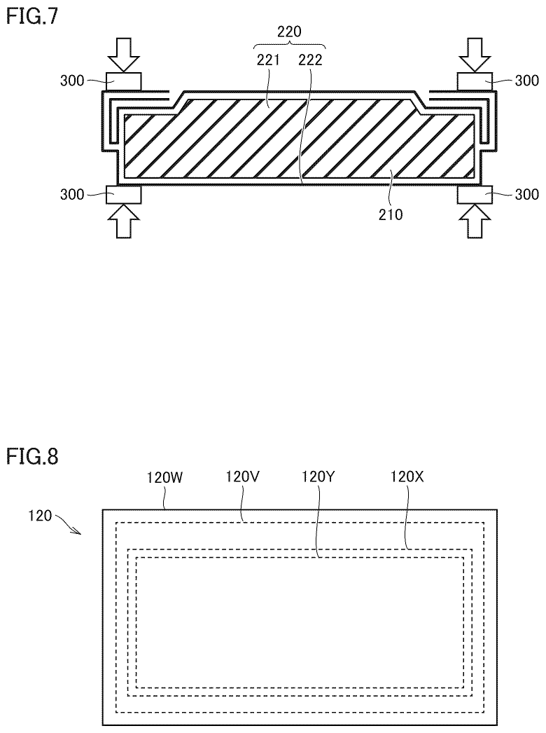

Next, a process of manufacturing separator 200 will be described with reference to FIGS. 5 to 7. First, as shown in FIG. 5, main body 210 is sandwiched between first film 221 and second film 222, and first film 221 and second film 222 are overlapped with each other at the end portions of main body 210. First film 221 and second film 222 overlapped with each other are joined to each other by an adhesion portion 224.

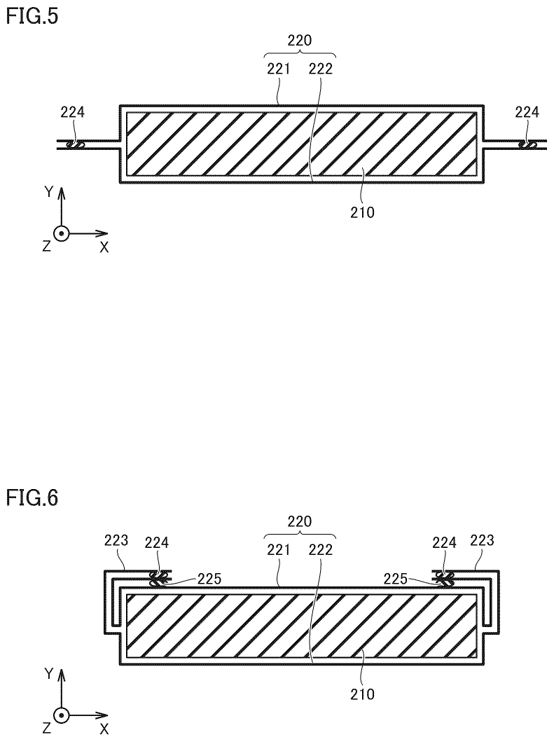

Next, as shown in FIG. 6, first film 221 and second film 222 overlapped with each other are folded back and overlapped with main body 210. First film 221 and second film 222 folded are joined onto main body 210 by an adhesion portion 225. Thus, fixation portion 223 is formed.

Next, the portion (folded and overlapped portions of first film 221 and second film 222) at which fixation portion 223 is formed is pressed in the Y axis direction using a jig 300. Thus, separator 200 shown in FIG. 3 is obtained.

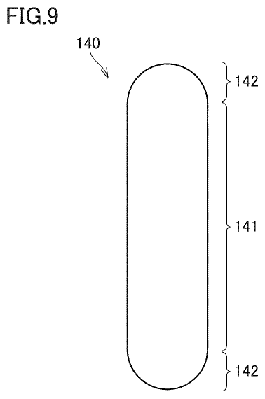

Next, a preferable range of fixation portion 223 will be described with reference to FIGS. 8 and 9. As shown in FIG. 8, a region 120Y in which electrode assembly 140 is in abutment with the inner surface of housing 120 (a region of a flat surface portion 141 other than curvature portions 142 in the case where electrode assembly 140 is of wound type as shown in FIG. 9), a region 120X in which pressing portion 232 of elastic body 230 is located, a region 120V located on the inner side with respect to fixation portion 223 (portion with which film 220 is overlapped), and a region 120W of each of first side surface 123 and second side surface 124 of housing 120 preferably have the following relation: region 120W includes region 120V, region 120V includes region 120X, and region 120X includes region 120Y.

Each of first side surface 123 and second side surface 124 of housing 120 preferably has a size (width or height) of about 50 mm or more and 500 mm or less in the X axis direction or the Z axis direction. Fixation portion 223 preferably has a size (width or height) of about 3 mm or more and 15 mm or less in the X axis direction or the Z axis direction. Fixation portion 223 preferably has a size (width or height) 0.006 times or more and 0.3 times or less as large as the size (width or height) of housing 120 in the X axis direction or the Z axis direction. Separator 200 is preferably provided across a whole of housing 120 in the X axis direction or the Z axis direction. It should be noted that the present technology is not limited to one having the above size relations.

Although the embodiments of the present invention have been described and shown in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery assembly comprising:
a plurality of batteries arranged in a first direction; and
an insulating member provided between the plurality of batteries, wherein
the insulating member includes a main body composed of a heat insulating material and having a plate shape, and a film that covers the main body, and
the film has a fixation portion that is folded back and fixed in an overlapping state at an end portion of the insulating member in a second direction orthogonal to the first direction.

2. The battery assembly according to claim 1, wherein the main body of the insulating member is formed to be relatively thin at a portion of the main body facing the fixation portion of the film.

3. The battery assembly according to claim 1, wherein the fixation portion has a size of 3 mm or more and 15 mm or less in the second direction.

4. The battery assembly according to claim 1, wherein
the main body of the insulating member is formed to be relatively thin at a portion of the main body facing the fixation portion of the film, and
the fixation portion has a size of 3 mm or more and 15 mm or less in the second direction.

5. The battery assembly according to claim 1, wherein
each of the plurality of batteries includes a housing that accommodates an electrode assembly, and
the fixation portion has a size 0.006 times or more and 0.3 times or less as large as a size of the housing of the battery in the second direction.

6. The battery assembly according to claim 1, wherein
the main body of the insulating member is formed to be relatively thin at a portion of the main body facing the fixation portion of the film,
each of the plurality of batteries includes a housing that accommodates an electrode assembly, and
the fixation portion has a size 0.006 times or more and 0.3 times or less as large as a size of the housing of the battery in the second direction.

7. The battery assembly according to claim 1, wherein
each of the plurality of batteries includes a housing that accommodates an electrode assembly, and
the insulating member is provided across a whole of the housing of the battery in the second direction.

8. The battery assembly according to claim 1, wherein
the main body of the insulating member is formed to be relatively thin at a portion of the main body facing the fixation portion of the film,
each of the plurality of batteries includes a housing that accommodates an electrode assembly, and
the insulating member is provided across a whole of the housing of the battery in the second direction.

9. The battery assembly according to claim 1, wherein
the insulating member further includes an elastic body configured as a member different from a member constituted of the main body and the film, the elastic body being stacked in the first direction,
the elastic body includes a base portion and a pressing portion, and
the pressing portion is provided to avoid the fixation portion of the film when viewed in the first direction.

10. The battery assembly according to claim 1, wherein
the main body of the insulating member is formed to be relatively thin at a portion of the main body facing the fixation portion of the film,
the insulating member further includes an elastic body configured as a member different from a member constituted of the main body and the film, the elastic body being stacked in the first direction,
the elastic body includes a base portion and a pressing portion, and
the pressing portion is provided to avoid the fixation portion of the film when viewed in the first direction.
